(19) United States
(12) Patent Application Publication
(10) Pub. No.: US 2006/0255066 A1
(43) Pub. Date: Nov. 16, 2006

(54) Food beverage dispensing system

(76) Inventors: David Kannar, Belgrave South (AU); Simon Michael, Williamstown (AU)

Correspondence Address: MORGAN & FINNEGAN, L.L.P., 3 WORLD FINANCIAL CENTER, NEW YORK, NY, 10281-2101, US

(21) Appl. No.: 10/543,932

(22) PCT Filed: Jan. 30, 2004
(86) PCT No.: PCT/EP04/00826

§ 371 Date: Jun. 28, 2006

Related U.S. Application Data
(60) Provisional application No. 60/443,856, filed on Jan. 31, 2003.

(51) Int. Cl. B67D 5/60; B65D 88/54; B65D 35/38

(52) U.S. Cl. 222/145.3; 222/287; 222/214; 222/494

(57) ABSTRACT

A food or beverage delivery system comprising at least one disposable or recyclable package containing viscous food therein; a dispensing apparatus having a holder for holding the food package and a pressure-displacement device that forces the food out of the package; and a valve; wherein the food package comprises an outlet portion which is part of the package, and wherein the valve is adapted to act in closure on the outlet portion to cut off portions of food coming out of the package without the food contacting the apparatus. The system may deliver frozen confection more hygienically with or without flavourings. The frozen confection may be a layered product with flavouring forming separations, bottoms or toppings. It may also be used to more accurately dose viscous beverage concentrates in a beverage dispenser.

### FIELD OF THE INVENTION

The invention relates to the automated dispensing of viscous food and beverage products such as those used in beverage dispensers or frozen confection dispensers such as soft ice cream in product containers. The invention also relates to the automated dispensing of a combination of frozen or refrigerated confection food and flavoring products such as sauces or syrups from the same machine in order to produce in a visually appealing way flavored or multi-flavored desserts. The invention also relates to an automatic dispensing apparatus adapted to provide automatically a freshly created dessert in a condition ready for consumption for a ready customer, preferably at the simple push of a button. The invention also relates to the accurate dispensing of beverage concentrates. The invention also relates to the product packaging adapted to such a method and apparatus.

### BACKGROUND AND RELATED PRIOR ART

In the foodservice industry today, customers increasingly desire to have foods and beverages automatically prepared and immediately available. Having such prepared foods of high quality and variety requires highly skilled labor. Such labor is increasingly in short supply and ever more expensive. This has led to an effort on part of the foodservice industry to rely increasingly on unskilled labor and, in turn, has led food processors to develop more processed foods requiring less skilled labor. Simultaneously, there can be significant food safety and hygiene concerns depending on the nature of the food or beverage being prepared. For example, dispensers that contain dairy products such as milk based beverages, or ice cream require special design by the machine manufacturers and attention by the machine operators. In addition to more processed foods, there is an industry of equipment suppliers providing the foodservice operators with equipment and specialty packaging that aids in the preparation of high quality meals and beverages by providing labor saving and improved hygiene solutions.

For many years there has been a steady stream of equipment developments by manufacturers in providing ready meals, but for high quality and value added desserts, the equipment is somewhat limited. One of the main areas of the dessert and snack menus includes ice creams and similar frozen desserts. Commonly in the foodservice area, processors provide to foodservice operators ice cream in bulk, which is scooped out from bulk containers into serving cups, dishes, or cones. The foodservice operator can also add by hand syrups, sauces, whipped cream, fruit, and the like to prepare a variety of delectable and visually appealing desserts in the categories of sundaes, parfaits, and so forth. This scooped “ice cream” can include products such a real ice cream, ice milks, sherbets, frozen ices, frozen yogurt, and the like. Often the visualization of the product that is presented to the consumer and the final product appearance is part of the sales experience. These ice cream products can be made on the premises, but are actually most often made at a factory and shipped to the foodservice establishment frozen in pre-packed containers.

Besides the availability of ice cream products in bulk for scooping, “soft serve” ice cream is also known. While such soft ice cream doesn't necessarily meet the legal definition of ice cream in many parts of the world, it has developed into a particular type of product that has its own identity in terms of typical formulas and serving temperatures, preferably at about −8 to −7° C., that are prepared in special machines at the foodservice establishments. There are a number of companies that manufacture these machines. At the foodservice establishment the machine takes a liquid mix, adds air and freezes the product for ready dispensing. Enhancements have been made by the manufactures for these machines to also add in syrups and the like into the soft serve as it is being dispensed. However, issues with these machines include: limited variety of products (no more than two), labor required to clean, sanitize and set-up the machines, machine cost, machine complexity, skilled maintenance required, and the fact that the machines have been known on occasion to have food safety problems when not properly cleaned and sanitized. Also, depending on the machine, the liquid product that is left over at the end of the day may have to be disposed resulting in a yield loss. Such machines also rely on the operator to manually open and close a valve and to use judgment as to the correct dispensing rate and serving size to prepare desserts made with soft serve. In some areas of the world and with some consumers, soft serve does not meet quality expectations.

Another area of the menu that has received more and more attention is value-added beverages such as lattes and cappuccinos which contain milk or other dairy ingredients. The preparation of beverages such as cappuccino requires highly skilled labor and is time consuming. While many of these dispensers prepare the beverages from powders (including milk powder), in order to get higher quality, some manufacturers have resorted to developing machines that rely on liquids as opposed to powders, e.g. concentrated milk. In addition, some of these machines use concentrates to supply all of the product needs such as chocolate and coffee based concentrates. Furthermore, sensitive products such as milk and other similar concentrates require package and equipment special design due to the hygienic needs of such food materials.

Typically, to meet the needs of accurate dosing in a hygienic manner for milk and similar concentrates (and other microbiologically susceptible products), concentrates are packed and supplied in bags, and the concentrates are dispensed with peristaltic pumps. The reasons for using peristaltic pumps are that they are fairly low in cost, and are hygienic—the concentrate does not directly contact the pump as this type of pumps works by using a set of rollers to move the product through tubing. However, with very viscous concentrates peristaltic pumps are known to have issues. At high viscosities, peristaltic pumps have trouble pumping accurately, if at all. Another issue is that when these concentrates are produced there can be lot-to-lot variations in viscosity and also the viscosity can vary significantly through shelf life and as a function of temperature. This adds to further dosing accuracy problems as typically dosing by the peristaltic pumps are time sequence controlled—as viscosity varies, the dose will vary to the point of producing beverages out of specification and of unacceptable quality. Thus, for such systems there is a need for an alternative dosing method of concentrates when the concentrates are very high in viscosity or when the viscosity significantly varies.

Thus, whether for frozen desserts or beverage concentrates, there is a need for an automated method of accurate, simple, and hygienic dispensing of highly viscous products.

Many attempts are in the art that attempt to solve some, but not all, of these problems using pre-filled packages.

U.S. Pat. Nos. 5,048,724 and 5,405,054 disclose an apparatus for dispensing ice cream from pre-packed bags. A bag of ice cream is supplied that has an outlet tube. This tubing is connected with a manually operated outlet valve. This outlet valve has a pinching mechanism to control flow. Thus, the bag is placed in compression by air pressure and the operator dispenses the ice cream by opening the valve, permitting frozen confection to flow. The system is not automated and there is no good control of the dispense rate, and thus poor portion control. In addition, some part of the machine still comes into contact with product, such as the dispensing spigot.

U.S. Pat. Nos. 5,069,364; 5,150,820; 5,215,222; 5,620,115; 5,632,415; 6,105,820; and 6,105,820 describe a dispensing apparatus for bulk pre-packaged ice cream. A deformable container pushed by a piston causes the ice cream through a small outlet and a duct and through a dispensing valve apparatus. However, this outlet duct and valve require separate cleaning. Various types of containers for the food material being dispensed are described. While there is a dispensing means and a shut-off means described, it is outside and separate from the package.

U.S. Pat. No. 5,417,355 describes a machine with rigid cartridges mounted in the interior of the machine with a valve assembly defining a passageway connecting the cartridge with an outlet opening. The valve assembly can also include a bladder. Again, ice cream flows through a passageway requiring cleaning, and refrigerated air is also used to keep the outlet valve cool.

U.S. Pat. No. 6,264,066 describes a dispensing system with a rigid container having a spout and a dispensing valve connected to the spout. Different designs of valves can be used to control the dispensing. While the valves have die shapes to allow different product shapes to be extruded, these valves are separate, not part of the package, and require separate cleaning.

U.S. Pat. No. 5,505,336 describes a collapsible container with pre-packaged ice cream. When placed in a refrigerated housing, a tubular member punctures the outlet of the bag to connect it to an outlet duct and manual control valve. Once again, the outlet valve is not part of the package and requires separate cleaning.

U.S. Pat. Nos. 5,893,485 and 5,918,767 both describe systems for dispensing from single portion containers rather than bulk containers. They are hand operated or may use a motor for power to dispense. No provision is made for controlling the dispense rate, however.

Attempts have been made at controlling dispensing rate to achieve portion control. Some patents describe methods of controlling dispense rate when air pressure, such as U.S. Pat. Nos. 5,421,484; 5,492,249; 5,779,098; 6,024,248; 6,068,160; and 6,325,244. Usually, an air driven piston pushes ice cream out of a bag through a duct to a control valve. Ice cream is in direct contact with duct and valve in these systems. The methods described in these patents have a measure of dispense rate control, but they are cumbersome and have operational shortcomings.

U.S. Pat. No. 6,435,377 describes the general design of using hydraulic fluid to apply pressure in a piston for dispensing ice cream from a container. The reason that there are efforts to control dispensing rate is that when using pneumatics or hydraulics, typically a constant pressure is applied which into the piston turns into a constant force which then translates into a constant pressure in the container of ice cream product. The problem with this is that the textural properties of ice cream vary, and with this, different pressures are required to achieve a constant dispensing rate.

Others attempts to directly achieve portion control from bulk packs include those described in U.S. Pat. Nos. 5,464,120 and 5,816,455, which describe a frozen dessert dispensing apparatuses that use a metering chamber to control the dispense portion size. This metering chamber, however, comes in direct contact with ice cream, which then requires cleaning.

Publication WO 02/085776 describes desserts that are dispensed from pre-filled containers that have an outlet and a moveable device to engage the container to force the product out. Included are detectors for sensing whether enough product is there and when dispensing is complete. Publication WO 02/102170 also describes a system in which ice cream is pushed into a flexible tube that has a valve on each end. The inlet valve allows product into the dispensing tube. The outlet valve on the tube is then opened and drive means is used to expel the product. It aims to control portions without manual operation of an outlet valve.

U.S. Pat. No. 5,823,387 describes a method and apparatus for dispensing a plurality of viscous materials. It contains a collapsible tube surrounding a core of a second viscous material of a contrasting color and uses a variety of dispensing nozzles.

U.S. Pat. Nos. 3,460,717 and 3,945,614 disclose methods of mixing nozzles that can be attached to typical soft serve machines. By pumping syrups or sauces through these nozzles as soft serve is dispensed, products can be made with the sauces or syrups dispersed throughout the final product, but these systems are only for soft serve machines and not for pre-packaged ice cream.

U.S. Pat. No. 6,453,803 describes various designs of sauce and syrup nozzles for attachment to soft ice cream machines. All designs have ice cream in contact with nozzle for giving interesting appearance products.

Typically, commercial machines that dispense soft ice dispense from single serve machines, which dispense ice cream from either a collapsible or from a rigid container and directly out into a cup or cone for serving. The machines that receive bulk containers dispense the product into a separate tube or passageway and then through a valve that must all be cleaned. In addition, all of these systems suffer from true dispensing rate and portion control.

Also, the prior art machines dispensing pre-packaged ice cream are not adapted to deliver multi-components product including sauces or syrups, in part because the existing machines cannot sufficiently control portion for those dispensing from bulk or, are single serve machines which also do not require dispense rate control. Such single serve packages, while giving a variety of products, require individual-portion packaging, which is expensive and does not allow for layering or co-dispensing.

Therefore, there is a need to have a quality frozen product from a simple, easy-to-use, machine with improved hygiene that can automatically dispense a variety of frozen desserts in a visually appealing way. There is also a need for a highly hygienic bulk packaged soft ice cream machine which has improved portion and rate control sufficient to be able to dispense a controllable combination of soft ice cream and flavoring such as sauces, syrups and topping and other solids materials.

There is also a need for an improved method of dosing and dispensing viscous liquids in beverage dispensing machines in a simple, accurate, and hygienic manner.

### SUMMARY OF THE INVENTION

The present invention can provide an automatic food or beverage dispensing system, and a method of use, adapted to deliver portions of viscous food in a more hygienic and more controlled manner.

The invention also provides an easy-to-use system, and a method of use, for automatically dispensing viscous food such as soft ice cream or a viscous liquid or a paste from a pre-packed container in a simple and economical way.

In the present application, “soft ice cream” means any sort of frozen semi-solid and/or viscous products including soft serve, slushes, milkshakes, frozen custard, slurries and the like.

The invention further provides a method of combining portion controlled frozen confection with a flavoring product such as sauces, syrups, and the like, that are dispensed automatically, consistently and in a coordinated manner to produce a visually appealing dessert.

A system according to the invention can include an apparatus and product containers and can be used by a method that decreases human interaction time. The improved dispensing rate control and portion control from pre-filled containers of frozen confection and the like is achieved with an improved hygienic configuration. A high level of control of dispensing rate is highly beneficial to repeatably dispensing visually appealing layered and other similar products.

An embodiment of the invention, the system comprises:

at least one disposable or recyclable package containing a viscous food therein;

a dispensing apparatus having a holder for holding the food package and a pressure-displacement device that forces the viscous food out of the package; and

a valve;

wherein the food package comprises an outlet portion, which is preferably an integrated part of the package, and wherein the valve is adapted to act in closure on the outlet portion to cut off portions of food coming out of the package without the food contacting with the apparatus.

In an embodiment, the valve is part of the package. In this embodiment, the valve is preferably a self-sealing valve. More particularly, the valve is integral to the outlet portion. Preferably it forms a ventricle which opens under the effect of the food pushing against the valve upon a positive pressure exerted by the pressure-displacement device on the package and which closes when the positive pressure is stopped. Preferably, after a predetermined time or volume dispensed, the valve is closed by exerting a vacuum in the package by the pressure-displacement device acting on the package to expand the size of the package; the ventricle having edges that cut off the food.

In a preferred aspect, the valve is arranged to confer to the dispensed food a certain defined shape such, as for example, a star, a round, polygonal or a character cross section.

In an embodiment, the ventricle comprises a plurality of edges of specific geometry and size that confers to the dispensed food the corresponding shape.

In another embodiment, the valve is part of the dispensing apparatus, but co-acts on an external surface of the outlet portion that does not contact the food. The outlet portion is preferably a flexible portion of spout or “pinch tube”. The valve so comprises a cut-off and shut-off mechanism which is part of the apparatus and which externally acts on the pinch tube. The cut off and shut off mechanism may include a die which externally acts by defining the desired section of the pinch tube. Such die may have different sections which so confer a corresponding deformation on the pinch tube to shape the product passing through the pinch tube accordingly. The cut off and shut off mechanism may be electrically actuated and controlled by drive and control means such as a solenoid that is selectively controlled by a controller of the dispensing apparatus. In a different embodiment, the cut off and shut off mechanism comprises a passive spring-loaded mechanism which closes when the pressure in the package is released.

In a preferred embodiment, the pinch tube is integral with at least the end wall of the package. Even preferably, the pinch tube is integral with the entire package. It can, for instance, be molded with the rest of the package from the same polymeric material.

In an embodiment, the package comprises a non-deformable cylindrical container portion and a pressurizing wall portion, forming at least a part of the plunger, which is moved inside the container portion upon compression thereon by the pressure-displacement device of the apparatus to force the food out of the outlet portion. Non-deformable containers have the advantage to avoid air gaps during filling and they do not split open and fold over onto themselves during dispensing, and consequently, they provide more constant dispense rates than collapsible containers.

In an alternative embodiment, the package comprises a deformable container portion and the pressure-displacement device of the dispensing apparatus comprises a movable plunger which applies a positive pressure on one end of the package to progressively reduce the length of the deformable container portion by compression against the holder, as food is dispensed out of the outlet portion of the package. Preferably, the container portion is preferably deformable in predictable locations to reduce the risk of the bag portion to fold over itself and create flow rate discrepancy. For instance, the container portion comprises a bellows-type wall.

In an important aspect of the invention, particularly when the valve is a self-sealing valve integrated to the package, there is a risk that the valve does not close sufficiently well and that product keeps being dispensed even after the pressure on the package by the pressure-displacement means is released. The problem may arise because the valve does not have sufficient force to cut off the product and/or the product is too viscous and/or the flow of product does not stop instantaneously when pressure is released due to the expansion rate of the product after being compressed.

Therefore, in order to better control the flow of dispensed food, the package comprises a container portion with a first end which is engaged with a connection means of the pressure displacement device and a second end supporting the outlet portion which is engaged with a connection means of the holder, and the two ends are moved apart a certain distance thereby enabling the size of the container portion to be expanded to create a vacuum in the package which assists in closing the valve. Preferably, the first end and second ends are moved apart by causing the first end to move away from the second end in reversing the direction of the pressure displacement device and by maintaining the second end stationary. In an alternative, the first and second ends are moved apart by causing the second end to move away from the first end and by maintaining the first end stationary.

In a preferred embodiment, the apparatus comprises at least one flavoring container, pump means and duct means arranged to transport the flavoring from the flavoring container and a nozzle in fluid connection with the duct means to dispense the flavoring around the flow of food.

In an embodiment, the nozzle comprises a center channel for the food to travel in axial direction through it and an annular block which has at least one internal channel configured to deliver the flavoring in a substantially circumferential downward direction around the food.

In another embodiment, the nozzle comprises a center channel for the food to travel in axial direction through it and an annular block which has at least one internal channel configured to deliver the flavoring in radial direction relative to the flow of food through the center channel.

In both embodiments, the nozzle is preferably placed below the holder or is preferably a part of the holder.

Preferably, the nozzle comprises at least two different inlets to be fed with two different flavorings from two separate flavoring containers and has separate channels to dispense each flavoring without cross-contamination.

The apparatus further comprises a controller, a user selection board in signal communication with the controller, the selection board having means for entering a flavor selection chosen from a plurality of flavor selections and software resident in the controller adapted to actuate the pump means of the selected flavoring either sequentially or simultaneously depending upon the selection.

The dispenser food can be a frozen confection such as ice cream and the like, a beverage concentrate or a food paste. When dispensing a frozen confection, the dispensing system comprises a refrigeration device for maintaining and dispensing the food package at the required frozen temperature. A heating device may replace the refrigeration device when dispensing warm or heated viscous food from the dispensing system.

A preferred method according to the invention for automatically preparing a flavored frozen confection with a visual layer differentiation includes:

entering a selection to the machine for a predetermined layer-differentiated frozen product;

dispensing a frozen confection from a container by co-activating a pressure-displacement device that forces the frozen confection out of the container and a valve to cut off portions of the frozen confection;

dispensing flavoring from a flavoring container by activating a pump;

wherein the dispensing of the frozen confection and the dispensing of the flavoring can be carried out sequentially or simultaneously depending upon the selection.

Preferably, the container is a disposable or recyclable package which includes the outlet portion of the valve in a manner that the frozen confection is dispensed without any contact with parts of the apparatus. The valve is also preferably an integrated part of the package which is arranged to hermetically close by exerting a vacuum inside the container, as aforementioned.

Furthermore, the method consisting of volumetrically dosing of a highly viscous liquid, especially beverage concentrates, from a non-deformable container by using a pressure-activated means has never been employed as an alternative to the traditional “peristaltic pump” dosing method. In particular, the system and method of the invention enable to overcome the viscosity variation problems usually leading to inaccurate dosing with the peristaltic pumps where the dose of concentrate is typically time sequentially controlled.

Therefore, another aspect of the invention is for a system for accurately dosing liquid beverage concentrate from a recyclable or disposable package in a beverage dispensing apparatus comprising:

at least one disposable or recyclable package containing beverage concentrate therein;

a dosing apparatus having a holder for holding the beverage concentrate package and a pressure-displacement device that forces the beverage concentrate out of the package;

a plunger; and

a valve;

wherein the beverage concentrate package comprises an outlet portion which is part of the package,

wherein the valve is adapted to act in closure on the outlet portion to cut off portions of concentrate coming out of the package without the concentrate contacting the dosing apparatus,

and wherein the beverage concentrate package has a non-deformable cylindrical container portion which directly contains the beverage concentrate therein and which forms the chamber for the plunger actuated by pressure-displacement device to travel in and to force beverage concentrate to expel through the outlet portion.

Therefore, for the viscous concentrate, the dosing accuracy is improved as compared to the traditional dosing with peristaltic pumps and the use of a non-deformable container in direct contact with the concentrate also participates to the dosing accuracy. Furthermore, the dosing is carried out more hygienically, therefore, less cleaning or rinsing is required.

Preferably, dosing of concentrate is obtained more accurately when the pressure-displacement device is activated by a controller of the dispensing apparatus which displaces the plunger an exact predetermined distance in the container. As liquid concentrate do not contain overrun compared to ice cream, the concentrate is not compressible and therefore dosing can be achieved at constant rate by programming distances of displacement of the plunger which thus correspond to the desired dosing for the particular beverages. For this, the system preferably comprises a displacement sensor which sends the signals to the controller for controlling the displacement of the plunger according to the exact predetermined distance. The sensor may be an encoder or any suitable equivalent means.

Additional features and advantages are described herein, and will be apparent from, the following Detailed Description and the figures.

### BRIEF DESCRIPTION OF THE DRAWINGS

FIG. 1a is an overall schematic perspective view of an embodiment of an automatic dispensing machine constructed according to the present invention;

FIG. 1b is an enlarged view of the interior of the machine in an area in which the ice cream product leaves the machine and is combined with dessert sauces;

FIGS. 2a, 2b and 2c are schematic views of an embodiment of a cut-off shut-off assembly of the machine in closed and open positions, respectively; FIG. 2c showing the assembly from below of the machine;

FIG. 3 is a front view an actuator connected to a plunger of the machine for pushing ice cream or highly viscous concentrate out of a composite can;

FIG. 4 is a front view of another embodiment of an actuator and plunger with a support tube shown pushing against a bag;

FIG. 5 is a view showing the machine use with a non-collapsible bag,

FIGS. 6A and 6B show a cut-off/shut-off valve based on a slide gate in open and closed positions, respectively;

FIGS. 7A-7E are top and front views of a self-closing or flapper valve of the present invention in an open position, in FIGS. 7A-7C, and in a closed position in FIGS. 7D and 7E;

FIGS. 8A-8B are a top and front view of a down-flow sauce nozzle of the invention;

FIGS. 9A-9E are top and front views of a radial-flow sauce nozzle of the invention;

FIGS. 10A-10C are top and front views of a tubular sauce nozzle assembly of the invention;

FIGS. 11 and 12 are, respectively, a perspective view and a cross sectional view of another embodiment of another type of package firmly clamped between an upper plunger and actuator and a lower holder;

FIG. 13 is a schematic perspective view of the cut off/shut off valve with an external die positioned for shaping the food product.

### DETAILED DESCRIPTION OF THE PREFERRED EMBODIMENTS

The system of the invention includes a dispenser adapted for dispensing a viscous food contained in disposable or recyclable containers.

The viscous food is meant to be a food having a viscosity ranging from 10 to 10⁶ centipoises. For frozen confection, the viscosity may usually range from 100 000 to 700 000 centipoises, preferably from 100 000 to 500 000 centipoises. For beverage concentrate, the viscosity is typically of from 10 to 10 000 centipoises. Milk concentrate is typically of from 200 to 1000 centipoises, chocolate concentrate is of from 800 to 3200 centipoises and coffee concentrate is of from 500 to 2000 centipoises. Much wider ranges are conceivable for concentrates and depend on the solids level. For instance, food paste exhibits much higher viscosity values than liquid concentrates.

The dispenser means preferably includes a pressure displacement mechanism to force the frozen confection under pressure through an outlet valve. For instance, the pressure displacement mechanism can be a plunger operated by a drive through the use of hydraulics, air pressure, or an electric motor.

The preferred pressure displacement mechanism includes an electric motor drive. The electric motor drive usually includes an AC or DC motor and a gear reduction and a shaft leading to the plunger. Therefore, through the use of a PLC (programmable logic controller) control system with timers or any equivalent controller, the displacement rate can be simply set through time selection. Preferably, the control system comprises a displacement sensing means, which detects the precise distance of displacement of the pressure displacement mechanism. Such sensor is typically an encoder which counts the rotations of the gear of the electrical motor drive. Thus, by simply counting the gear rotations and sending such signal to the controller for the controller then to control the de-activation of the device accordingly, the variation of the speed of the motor under load does not affect the dosing accuracy.

A frozen confection such as ice cream and the like, however, is usually compressible as function of the overrun rate of the product. Thus a controller and a displacement sensor are preferably used to deliver controlled portions of ice cream.

To make layered products, in addition to the dispenser, a cut-off and shut off device is used to produce clear breaks in the ice cream and to stop the flow of ice cream precisely when desired. The displacement sensor sets the distance traveled by, for example, a plunger of the displacement mechanism, which determines the volume dispensed. The cut-off/shut-off device can comprise a valve, such as a plug valve, slide gate valve, pinch valve, iris valve, or other suitable type. The most preferred valve type is a pinch valve, which can be an integral part of the container.

The valve can be a separate device that is part of the machine and requires cleaning, or preferably is part of the food product package. In a preferred embodiment, there is no contact between product and the machine, only contact with the package itself. This is most preferred from a hygienic standpoint as the packaging will be disposed when the container is empty.

The type of packaging that can be used is varied and can include flexible and non-flexible (rigid) containers. Included in the flexible category are pouches, bags, and so forth. Rigid containers can be composite cans, plastic cylinders, and so forth. Another category may combine rigid outer containers with internal flexible bags. In all of these packages, at least the part of the outlet valve in contact with the food, is preferably integrated as part of the package, and is of integral or even unitary construction therewith. In some cases, such as when using cans, a plunger assembly can be part of the package, and in others it is part of the machine and is not replaced with the package. Flexible packages such as plastic bags may employ support cylinders, while rigid containers can easily be used without such additional support. A support cylinder can be installed as a permanent rigid support of the apparatus. The containers can also be mounted in the machine in a carrousel manner to give a variety of products.

One type of a non-collapsible container has an O-ring type seal as part of the package that is held in place in the support tube. The plunger comes down through the bag so the container itself is not collapsed.

As a result of the inventive machine and method, whether simple products such as cones or more complex products such as parfaits and sundaes automatically are produced, portion control is provided for ice cream and other layered products.

To dispense a combination of ice cream products and flavorings, such as sauce or syrups, a sauce nozzle assembly is positioned below the outlet control valve. Various embodiments of sauce nozzle assemblies are described below for the inventive machine.

A simple flavoring nozzle embodiment is a down-flow or axial flow nozzle. This is part of the machine and requires parts to be taken apart and cleaned. Flavoring is pumped by any variety of pumps which are connected to a reservoir of sauce or syrups through tubing that is connected to the nozzle. In a preferred embodiment, the flavoring is supplied in bags or pouches or other types of packaging to be disposed when finished so as to not require cleaning. Such packaging for sauces may be bags, pouches, or cans, for example. The tubing can be part of the machine, which would require cleaning, or can be disposable, which is preferred. The flavoring, such as the sauces or syrups, can be any suitable variety such as chocolate, caramel, fruit sauces, etc. The flavorings can be used at refrigerated temperatures, ambient, or even held hot to make a product like a hot fudge sundae.

Other flavoring nozzle embodiments include radial flow nozzles. Still other nozzles are rigid tube assemblies with suitable dispensing holes, and others are the soft tubing itself. In one machine version, the flavoring nozzle may swing out of the way so as to not interfere with the process of making cones. The flavoring nozzles can direct the flavoring in any desired direction, such as directions oriented between an axial and radial flow.

Other products that can be automatically dispensed include solid pieces, slushes, and liquids such as coffee concentrates.

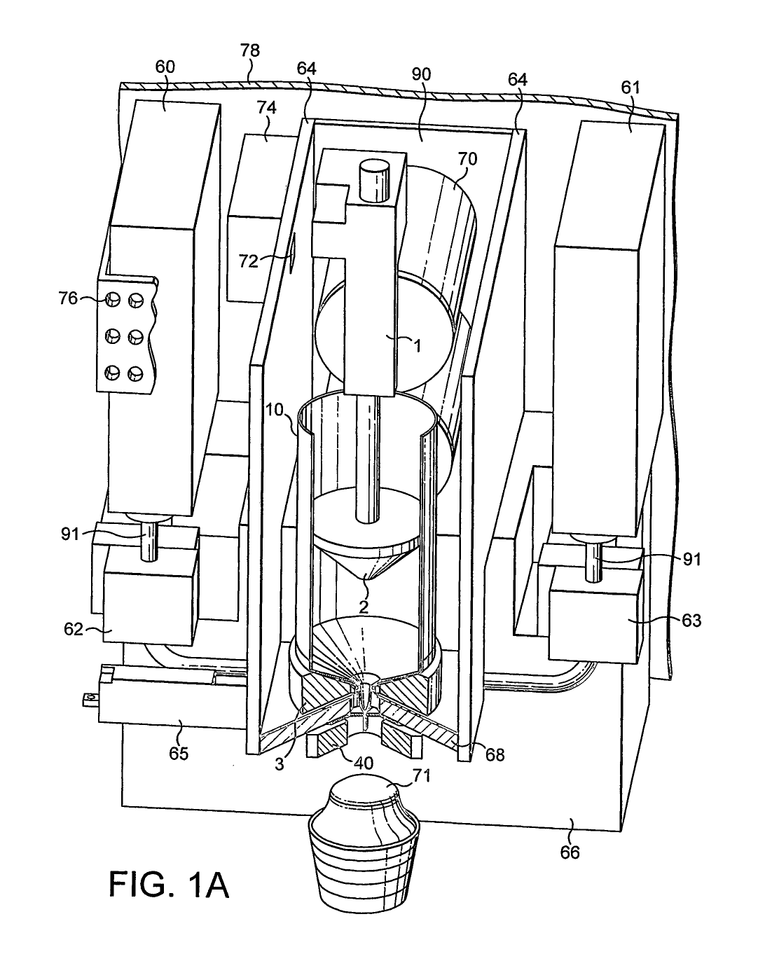

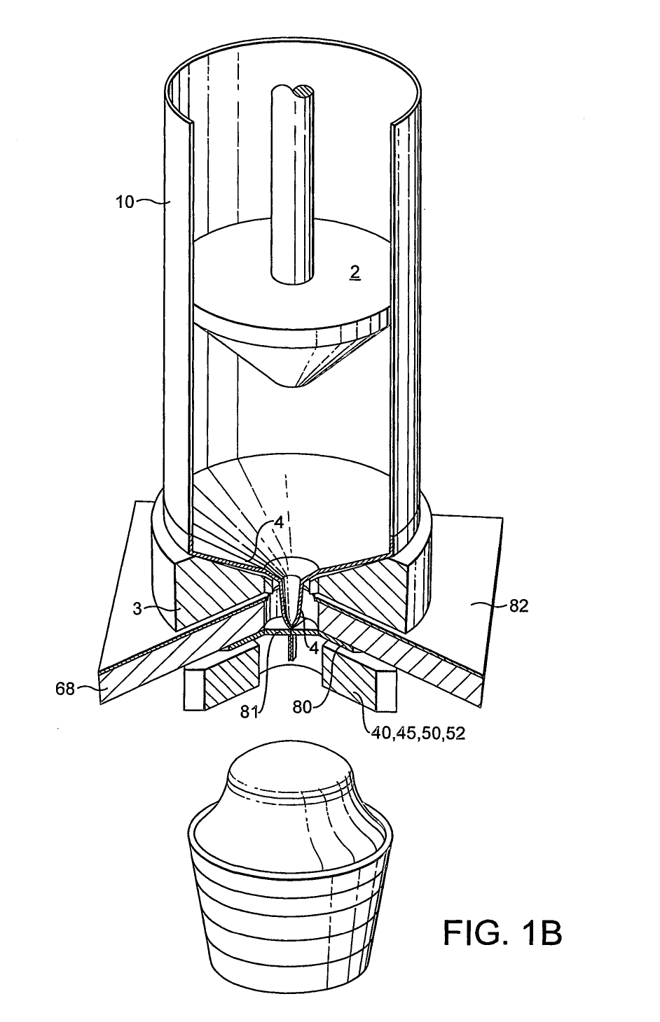

Referring to FIGS. 1a and 1b, the schematic shows the basic design of the dispensing system. A housing 78 preferably encloses the mechanisms of the system and is used for branding and to convey to the customer the nature of the products to be sold. Also on the exterior of the machine is a user selection board with buttons 76 or other controls for selecting specific products and or dispensing activities.

There is a freezer chamber 90 in this embodiment that is used to hold product cold, preferably in a frozen state, tightly controlled to a specified temperature usually between −6 and −24° C. and preferably between −12 to −18° C. This freezer chamber 90 is cooled with a compressor refrigeration system 74 that sends refrigerant through the walls of the chamber 64. There may be included a fan with the refrigeration system 74 to help circulate air. A temperature sensor 72 is connected to a control circuit for temperature control. Inside of the freezer chamber 90 is the container of ice cream 10, that is being used for dispensing, and reserve containers 70, that are used at the ready to be quickly changed. A composite can 10 is shown in FIG. 1a, as the package for the ice cream, but other types of packages can alternately be used.

FIG. 1a also shows the electric motor drive actuator 1 that is in contact with the plunger 2 to move the plunger 2 preferably in a straight path to dispense the ice cream. The motor of the actuator is turned on and off by a PLC control or any other suitable sort of controller. A displacement sensor can advantageously be provided which is arranged to control the distance traveled by the plunger. Such sensor may be an encoder or any equivalent means which makes a count of the rotation of the gear means of the motor drive actuator. The ice cream is pushed from the container 10 out of the container though the outlet 4 by a downward movement of the plunger 2. As ice cream is a slightly compressible material, the operator has the option of using a feature whereby at the end of a downward movement of the motor, the motor will automatically move the piston 2 in an upward direction to relieve the pressure.

The dessert sauces or other liquid food products used are stored in bags in boxes 60, 61 or other types of packaging. In the embodiment shown, there are two sauces, but for some features of the invention, none, one, two or more sauces may be used in different machine models. Depending on the type of sauces, the sauces may be kept at ambient temperature, may be cooled, or may be heated to a hot state to produce a hot fudge sundae, for instance.

In the version shown in FIG. 1a, the sauces travel through tubes 91, which are preferably flexible, through preferably peristaltic pumps 62 and 63 that are electric motor driven. The tubing 91 is connected with the sauce nozzles 40 for dispensing.

Referring to FIG. 1b, the ice cream container 10 fits into a base or holder 3 to support the container 10 during the dispensing and allowing quick and easy changing by the operator. Depending on the package used, a support tube may be used for flexible packaging to hold the package and provide support during dispensing. The base may be made of a highly thermally conductive metal such as aluminum to carry any heat away from the lower part of the ice cream package and prevent or significantly reduce melting of the frozen product.

Below the metal cold plate is an insulating support plate 82, then an exterior support surfaces 68 are below and outside thereof. Preferably disposed below the exterior bottom surface of the machine is a cut-off/shut-off mechanism 81 and sauce nozzle assembly 40. The cut-off/shut-off mechanism can be actuated by a motor drive 65, shown in FIG. 1a, or another mechanism such as an electrically operated device, such as a solenoid switch.

By programming a PLC, the operator can dispense any variety of products from a simple cone or only ice cream in a cup to products with complex structures such as with layers or with stripes as a result of co-dispensing. The frozen confection may be a layered product with flavouring forming horizontal, sloped or vertical separations, bottoms or toppings. This can be done through the use of programmed timers or displacement sensors, with each timer or sensor operating motors 1 and 65 for dispensing of the ice cream, and pumps 62 and 63 for sauce. For instance, on a time selection basis, if a product is desired that has sauce on the bottom, then a layer of ice cream above it, and another layer of different sauce on top, the operator may program, 2.0 s of sauce A, followed by 5.0 s of ice cream, followed by 2.0 s of sauce B. Of course, other products can also be made with intermittent layering or by running the ice and sauce dispensing simultaneously.

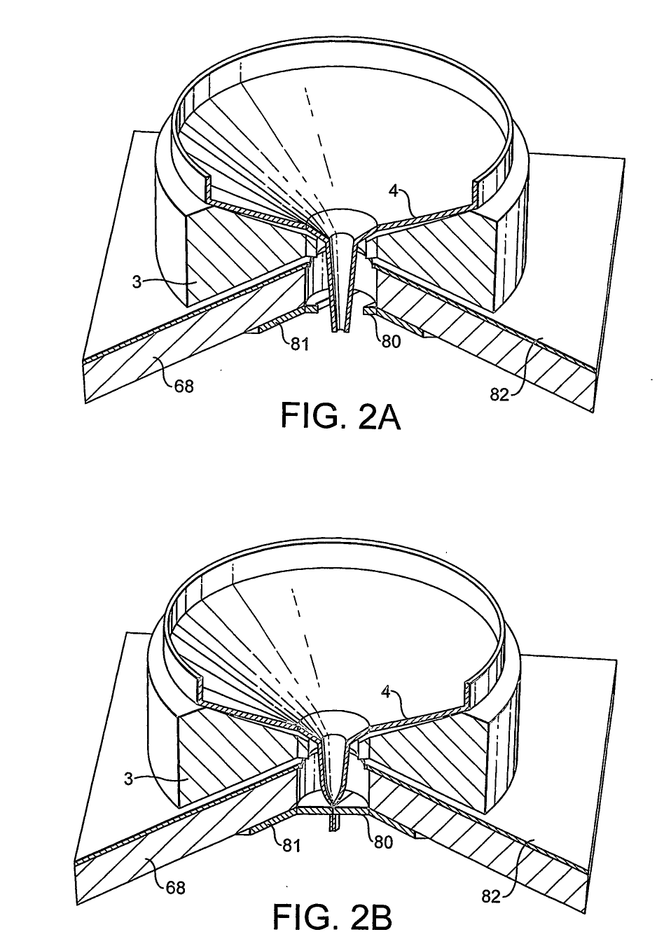

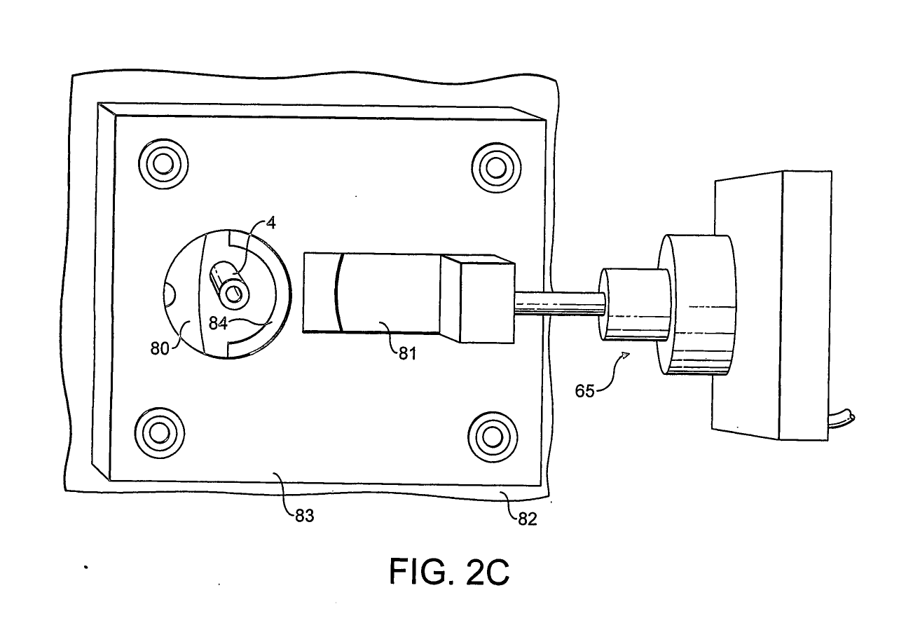

FIGS. 2a, 2b and 2c, provide a better detail of the closing mechanism, which in this embodiment is a pinch tube 4, selectively opened and shut off by a closing gate. The closing gate is formed of two parts 80, 81. A first half 81 of the gate is a moving part operated by the solenoid and motor 65. The first half 81 is maintained in sliding arrangement between the upper support plate 68 and a lower support plate 83 (shown in FIG. 2C only). In a possible embodiment, the lower support plate 82 and the sauce nozzle 40 are the same element. The other half 80 of the closing gate is a stationary part. The lower support surface comprises a central passage 84 for connecting the sauce nozzle 40. A connection means such as a bayonet type connection or threads is provided in the passage 84 for securing the nozzle.

FIG. 2b shows the closing mechanism in the closed position with a positive closure of the outlet pinch tube 4, which is integral with the package 10, while FIG. 2a shows the open position. Through the PLC, the opening and closing of the pinch valve is sequenced and timed with the main drive motor acting on the plunger.

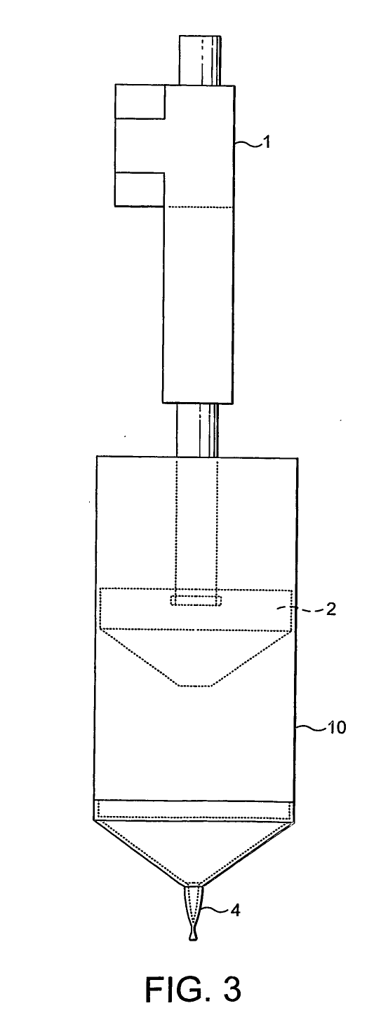

FIG. 3 shows more detail of a plunger 2 being acted upon by the actuator 1 that is driven by an electric motor. In the embodiment shown with a non-deformable package 10, the plunger 2 preferably has a corresponding shape and angles as the bottom of the package so as to provide a high as a yield as possible. The plunger 2 may be a part of the package or, alternatively, be a part of the actuator 1. The plunger may thus be utilized as a lid for the cylindrical container 10 which closes the upper end of the container, while the lower end of the container is closed by the outlet portion comprising the nozzle 4. The connection between the plunger and the drive shaft can be made by any suitable means such as by screwing, press fitting and the like. The plunger is dimensioned to fit relatively closely with the sliding surface of the container to avoid air coming in the container. The outlet portion may be formed, together with the nozzle, of an integral piece of plastic or rubber which can be tightly fixed to the lower end of the container portion by any suitable connection means such as by gluing, welding or by a mechanical collar. The end of the nozzle can be crimped to ensure airtight storage of the product inside the package before the first use. The tubular container may be made of rigid cardboard, plastic, a composite of plastic and cardboard, metal or any suitable material. The sliding or inner surface of the container may be treated or coated with materials which reduce frictions with the plunger. The package and device of FIG. 3 can be utilized for dispensing ice cream but also, advantageously, for dosing highly viscous concentrate such as coffee, milk or cocoa.

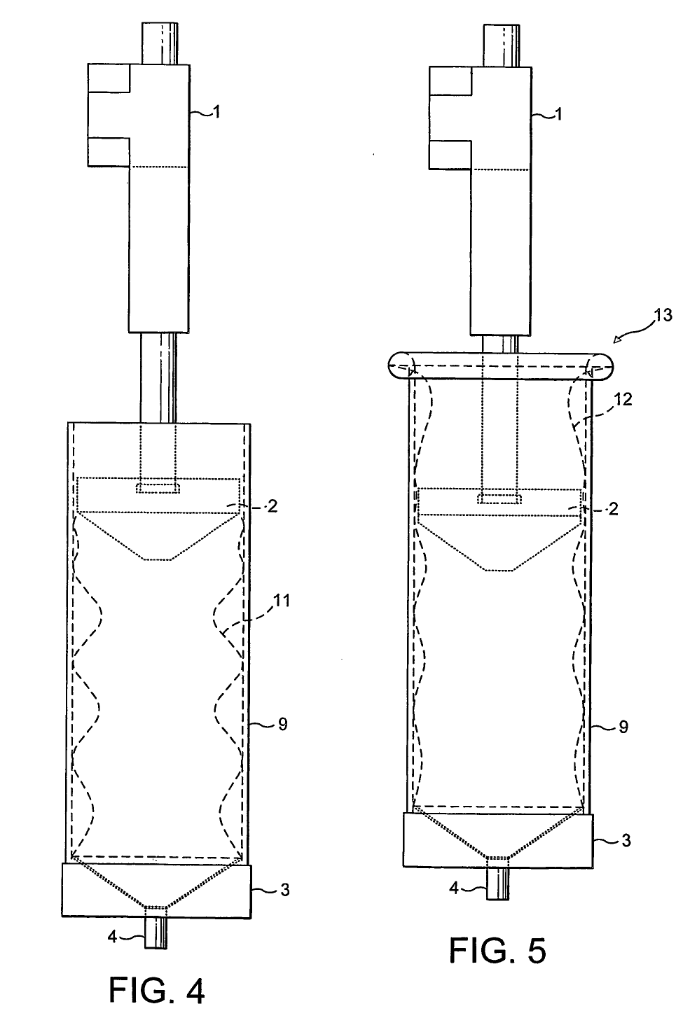

FIG. 4 shows a deformable container 11, such as a bag, being used. This employs a separate plunger 2 that is not part of the package, as opposed to when using a can, in which a plunger that is part of the container is preferably used. A support cylinder 9 of the machine is preferably provided to support the flexible packaging in the machine and during dispensing. In a possible embodiment, the support cylinder can be an external protection sleeve of the package; in which case, the plunger may be part of the package. The plunger 2 can be moved in the upward direction to relieve some of the pressure developed at the end of a discrete dispensing operation.

The package of FIG. 5 is flexible and includes a bag portion, but is configured to support the bag portion, such as in tension, to keep it from collapsing as the plunger drives downwardly, sliding within the bag portion to displace the ice cream, instead of collapsingly deforming the bag portion as in the embodiment of FIG. 4. The sidewalls of the bag are supported by the support cylinder 9, and the bag is held in place by an o-ring 13 that overlays onto the top of the support cylinder.

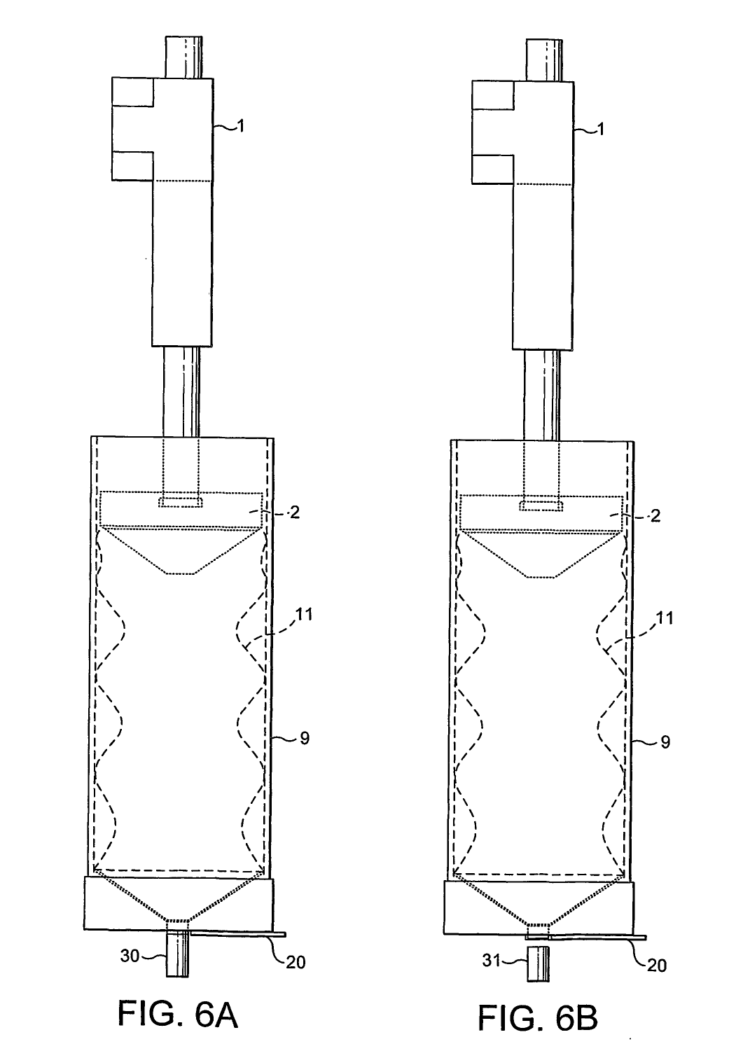

FIGS. 6A and 6B show the typical operation of a slide gate 20 that acts as the cut-off/shut-off means that in this case directly contacts the ice cream. FIG. 6a shows the open position when the ice cream is being dispensed, while FIG. 6b shows the slide gate in the closed position when dispensing is complete.

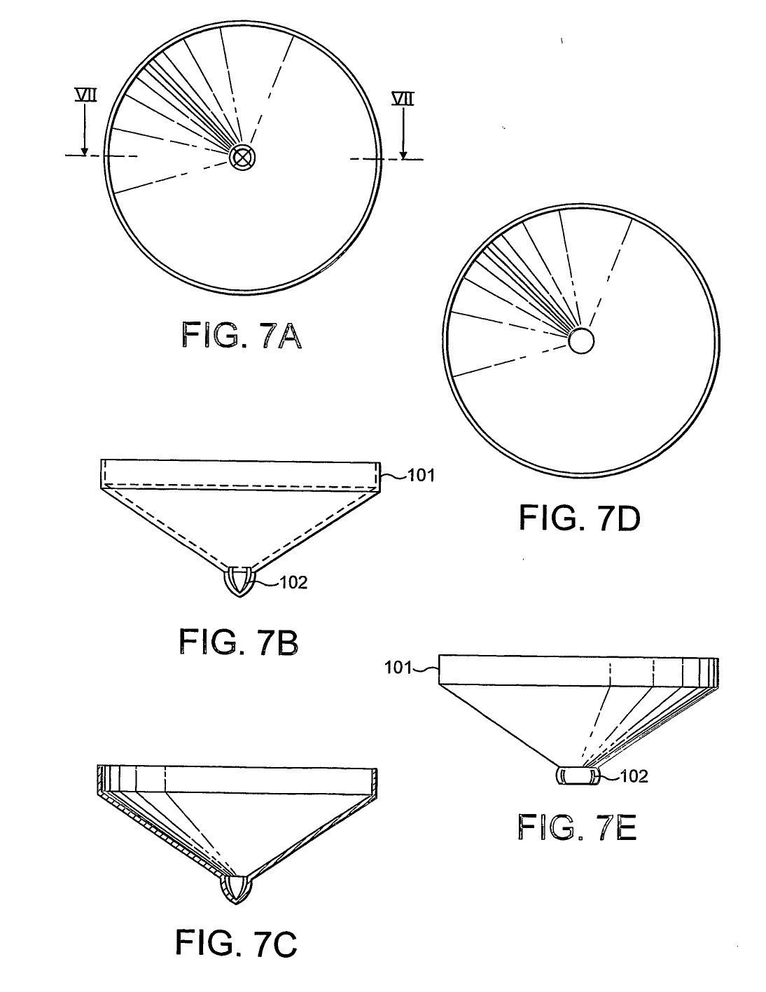

FIGS. 7A-7E show a self-closing valve, such as a flapper valve 102 in the open and closed positions. The valve is integral to the dispensing wall of the package. It forms a ventricle with a plurality of cutting edges demarcating a pattern of cuts produced in the plastic or rubber of the outlet portion itself. The material of the valve is rigid enough to cut off portions of food by the edges of the cuts when it closes off. Unlike other valves, no motor drive assembly is required, as it is self-closing, such as upon release of pressure within the container. Closing of the valve may require with the more viscous materials that at least a slight vacuum is drawn in the container. For this, at the end of the dispense cycle, the control pulls the plunger back a certain magnitude necessary for creating a vacuum in the container and for the valve to properly close without product dripping from the nozzle. Therefore, the opening and closing control of the self-closing valve by way of the combination of the valve itself and the operation on the plunger. Such control of the flow rate is therefore much simpler and more hygienic compared to existing dispensing systems using typical shut off valve where the product flows through.

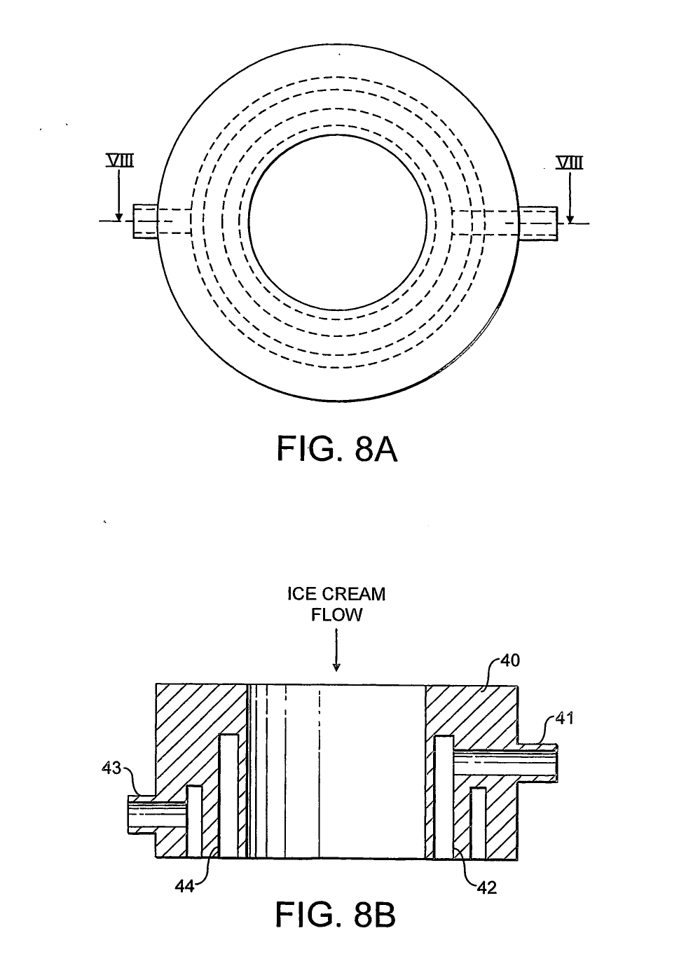

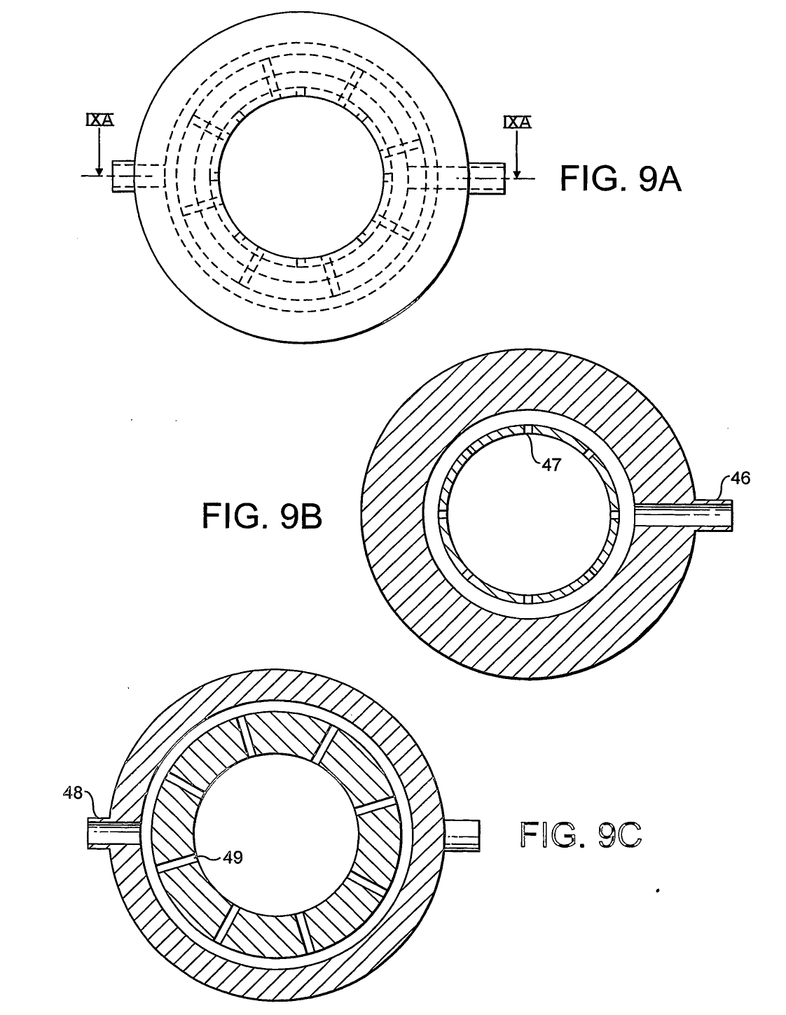

FIGS. 8A and 8B show a down-flow sauce nozzle 40. The nozzle comprises an annular block with a main center channel through which ice cream can flow. Different sauces enter the nozzle at nozzle inlets 41 and 43, travel in a circumferential direction in inner concentric channels placed around the center channel, and exit in a downward direction from outlets 42 and 44. Ice cream, as it is dispensed, flows downwardly through the center channel of the nozzle assembly as shown, preferably without making contact with the sauces.

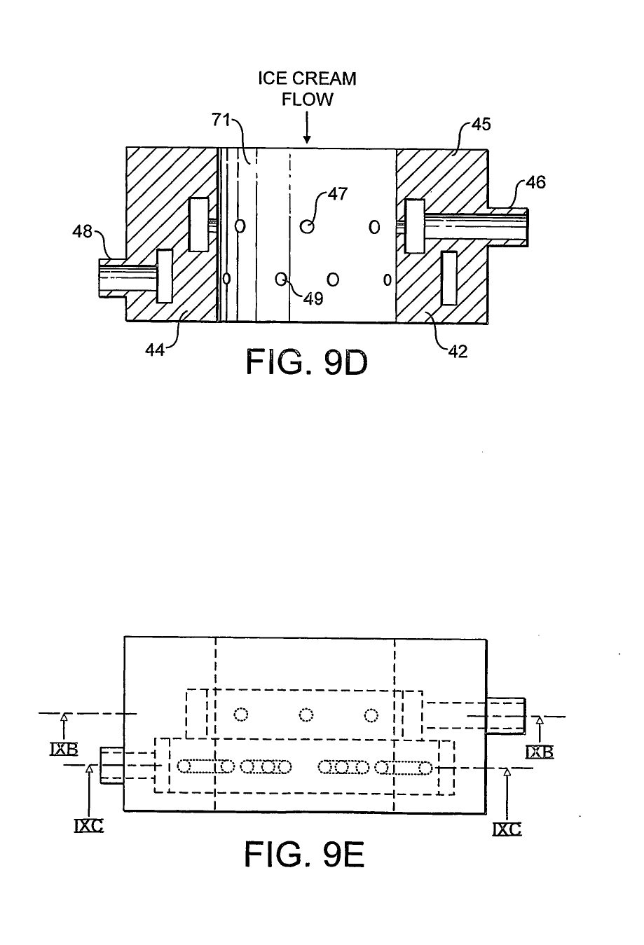

FIGS. 9A-9E show a radial-flow sauce nozzle 45. This is similar to sauce nozzle 40, except that the sauce exits the nozzle, from concentric inner channels through a plurality of small outlets 47, 49, in a radial direction inward towards the flowing ice cream in center channel 71.

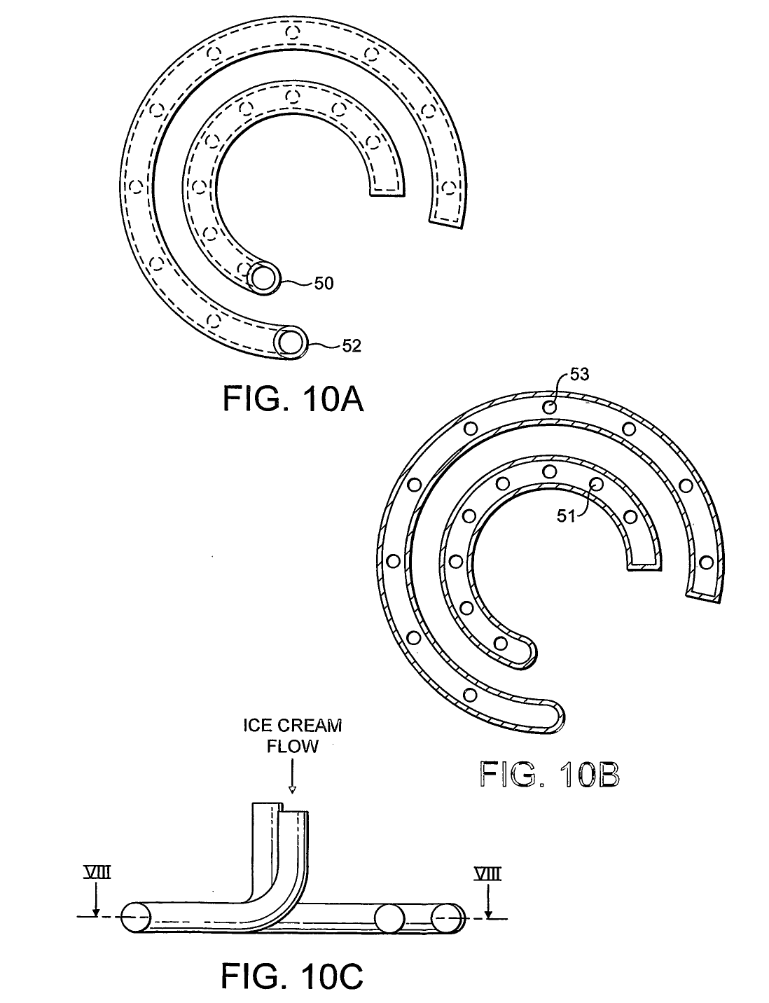

FIGS. 10A-10C show an embodiment of a tubular nozzle assembly that includes tubular nozzles 50 and 52. In this nozzle assembly, each tubular nozzle is connected to the peristaltic pump tubing. Such tubular nozzles can be “permanent”, as a part of the machine, or can be disposable.

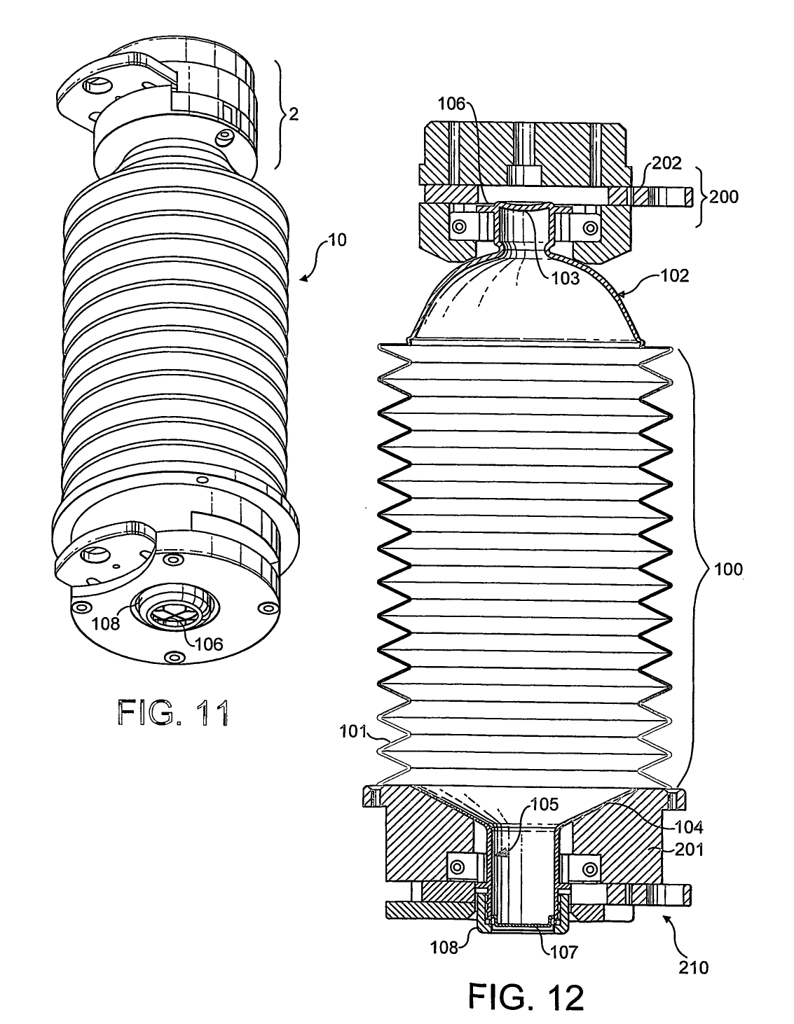

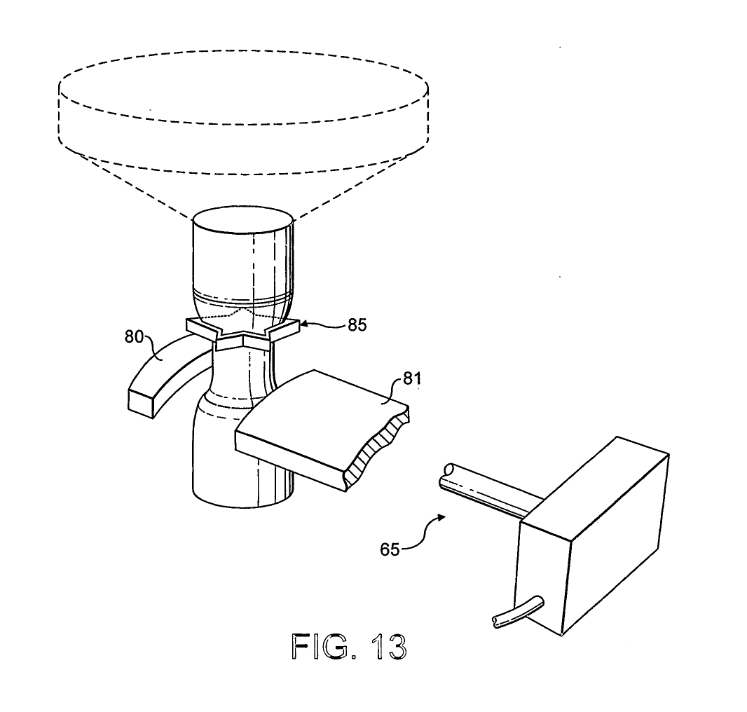

FIGS. 11 and 12 show another embodiment of the invention. The package 10 comprises a main deformable portion 100 which can be submitted to compressions and expansions in a reproducible and repeatable manner. The main portion has preferably a bellows configuration with a plurality of transversally oriented concertinas 101. The upper end of the package has a spigot 103 with a flange 106 which can be maintained firmly fixed by a clamping mechanism 200 using a locking plate 202 of an upper plunger 2. The spigot could also be fixed by press-in or screw-on type mechanism or any equivalent connection means of the pressure-displacement device. The lower end 104 of the package is held by a stationary holder 201 and centrally protrudes by an outlet hose 105 which is also firmly held by a clamping mechanism 210, or by press-in or screw-on type mechanism or any equivalent means. The package is thus suspended upside down with the outlet hose facing downwards. The outlet hose is closed by a self-closing or ventricle type valve 106, for example, an insert 107 which is press fitted within a cap 108 screwed on the hose.

The valve 106 is configured to open once a predetermined level of positive compression force is achieved by the plunger 2 of the pressure-displacement device on the container, allowing product to be extruded into a receptacle placed directly below the hose 105. After a predetermined time or travel distance of the plunger, corresponding to a certain volume of product extruded, the plunger 2 reverses, i.e., moving back a certain distance toward its starts position. This action causes the size of the package to expand from its compressed state and it creates a vacuum within the package causing the pressure of product on the valve to release and the valve 106 to shut off. Further loss of product is therefore prevented. The design of the valve may encompass multiple variations which may effect the design of the extruded product.

The valve surface is preferably sealed for protection before use by a conventional plastic peel able label seal for instance.

FIG. 13 shows the cut off and shut off mechanism used in conjunction with an external die arranged for shaping the food coming out of the pinch tube 4. If a product shape needs to be given, the pinch tube may be made of a thin wall and maintained within an external die 85 of defined shape such as a star, polygonal shape or any sort of characters (die not represented). The die 85 may be a ring of thickness of a few millimeters only, for example, 1-5 mm. The die is positioned above the slide gate 80, 81. The die may be removably supported by the support plate (not shown). The section of the die is preferably lower than the section of the thin tube such that when the food is compressed in the tube, the tube can conform properly to the die shape. The tube may also be elastic to conform to a die of larger section. The advantage of an external die lies in the fact that it remains clean after dispense and so does not require any cleaning. Alternatively, the die could be internal in the pinch tube or could be attached to the end of the pinch tube.

The cut off and shut off valve may include many mechanical variations. For example, the valve may be conceived on the principle of a deformable parallelogram or a cam mechanism.

While illustrative embodiments of the invention are disclosed herein, it will be appreciated that numerous modifications and other embodiments may be devised by those skilled in the art. Therefore, it will be understood that the appended claims are intended to cover all such modifications and embodiments that come within the spirit and scope of the present invention.

1. A food or beverage delivery system comprising:
at least one food package containing a viscous food therein;
a dispensing apparatus having a holder for holding the food package and a pressure-displacement device that forces the food out of the food package;
a valve;
the food package comprises an outlet portion which is part of the food package, and
the valve is adapted to close the outlet portion to cut off portions of food coming out of the food package without the food contacting the apparatus.

2. Food or beverage delivery system according to claim 1, wherein the valve is part of the food package.

3. Food or beverage delivery system according to claim 2, wherein the valve is integral to the outlet portion.

4. Food or beverage delivery system according to claim 3, wherein the valve forms a ventricle which opens under the effect of the food pushing against the valve upon a positive pressure exerted by the pressure-displacement device on the food package and which closes when the positive pressure is stopped.

5. Food or beverage delivery system according to claim 4, wherein, after a predetermined volume is dispensed, the ventricle is closed by exerting a vacuum in the package by the pressure-displacement device acting on the package to expand its size.

6. Food or beverage delivery system according to claim 4, wherein the ventricle comprises a plurality of edges of specific geometry and size that confers to the dispensed food a corresponding shape.

7. Food or beverage delivery system according to claim 3 wherein the food package has a cap or insert that fits a neck portion of the food package and supports the valve.

8. Food or beverage delivery system according to claim 1, wherein at least part of the valve forms a part of the dispensing apparatus which co-acts on an external surface of the outlet portion without contacting the food.

9. Food or beverage delivery system according to claim 8, wherein the valve comprises a cut-off and shut-off mechanism, which is a part of the apparatus, and which externally acts on a pinch tube which is a part of the food package.

10. Food or beverage delivery system according to claim 9, wherein the cut-off and shut-off mechanism is electrically actuated and controlled by drive and control means of the apparatus.

11. Food or beverage delivery system according to claim 9, wherein the cut-off and shut-off mechanism is a passive spring-loaded mechanism which closes when the pressure in the food package is released.

12. Food or beverage delivery system according to claim 9, wherein the pinch tube is integral with the food package.

13. Food or beverage delivery system according to claim 1, wherein
the food package comprises a non-deformable cylindrical container portion and a pressurizing wall portion, forming at least a part of the plunger, which is moved inside the container portion upon compression thereon by the pressure-displacement device of the apparatus to force the food out of the outlet portion.

14. Food or beverage delivery system according to claim 1, wherein
the food package comprises a deformable container portion and,
the pressure-displacement device of the dispensing apparatus comprises a movable plunger which applies a positive pressure on one end of the package to progressively reduce the length of the container by compression against the holder, as food is dispensed out of the outlet portion of the package.

15. Food or beverage delivery system according to claim 14, wherein
the container portion is deformable in a predictable manner.

16. Food delivery system according to claim 15, wherein
the container portion comprises a first end which is engaged with a connection means of the pressure displacement device and a second end supporting the outlet portion which is engaged with a connection means of the holder, and the two ends are moved apart a certain distance thereby enabling the size of the container portion to be expanded to create a vacuum in the food package which assists in closing the valve.

17. Food or beverage delivery system according to claim 1, wherein the apparatus comprises:
at least one flavoring container,
pump means and duct means arranged to transport the flavoring from the flavoring container and,
a nozzle in fluid connection with the duct means to dispense the flavoring around the flow of food.

18. Food or beverage delivery system according to claim 17, wherein
the nozzle comprises a center channel for the food to travel in an axial direction through the nozzle and an annular block which has at least one internal channel configured to deliver the flavoring in a substantially circumferential downward direction around the flow of frozen confection.

19. Food or beverage delivery system according to claim 17, wherein
the nozzle comprises a center channel for the food to travel in axial direction through the nozzle and an annular block which has at least one internal channel configured to deliver the flavoring in a radial direction relative to the flow of food through the center channel.

20. Food or beverage delivery system according to claim 17, wherein the nozzle is located below the holder.

21. Food or beverage delivery system according to claim 17, wherein the nozzle comprises at least two different inlets to be fed with two different flavorings from two separate flavoring containers and has separate channels to dispense each flavoring without cross-contamination.

22. Food or beverage delivery system according to claim 17 wherein the apparatus further comprises:
a controller,
a user selection board in signal communication with the controller, the selection board having means for entering a flavor selection chosen from a plurality of flavor selections, and
software resident in the controller adapted to actuate the pump means of the selected flavoring either sequentially or simultaneously depending upon the selection.

23. Food or beverage delivery system according to claim 22, wherein the pressure-displacement device is activated by the controller of the dispensing apparatus which displaces the plunger an exact predetermined distance in the container.

24. Food or beverage delivery system according to claim 1, wherein the food is a frozen confection.

25. Food or beverage delivery system according to claim 1, wherein the food is a beverage concentrate.

26. A method for automatically preparing a flavored frozen confection with a visual layer differentiation from a dispensing apparatus including:
entering a selection to the dispensing apparatus for a predetermined layer-differentiated frozen product;
dispensing a frozen confection from a container by co-activating a pressure-displacement device that forces the frozen confection out of the container and a valve to meter portions of the frozen confection;
dispensing flavoring from a flavoring container by activating a pump; and
the dispensing of the frozen confection and the dispensing of the flavoring being performed sequentially or simultaneously depending upon the selection.

27. Method according to claim 26, wherein the container is a disposable or recyclable package which includes the outlet portion of the valve in a manner that the frozen confection is dispensed without any contact with parts of the dispensing apparatus.

28. Method according to claim 26, wherein the valve is an integrated part of the package which is arranged to hermetically close by exerting a vacuum inside the container.

29. System for accurately dosing liquid beverage concentrate from a recyclable or disposable package in a beverage dispensing apparatus comprising:
at least one disposable or recyclable package containing beverage concentrate therein;
a dosing apparatus having a holder for holding the beverage concentrate package and a pressure-displacement device that forces the beverage concentrate out of the package;
a plunger;
a valve;
the beverage concentrate package comprises an outlet portion which is part of the package,
the valve is adapted to close the outlet portion to cut off portions of liquid concentrate coming out of the package without the concentrate contacting the dosing apparatus, and
the beverage concentrate package has a non-deformable cylindrical container portion which directly receives the beverage concentrate therein and which forms the chamber for the plunger actuated by the pressure-displacement device to travel in and to force beverage concentrate to expel through the outlet portion.

30. System according to claim 29 wherein
the pressure-displacement device is activated by a controller of the dispensing apparatus which displaces the plunger an exact predetermined distance in the container.

31. System according to claim 30 comprising
a displacement sensor which provides the controller the signal for controlling the predetermined distance of displacement of the plunger.

32. System according to claim 29, wherein
the plunger is part of the package.

33. Food or beverage delivery system of claim 1 wherein the package is a recyclable package.

34. Food or beverage delivery system of claim 1 wherein the package is a disposable package.

35. Food of beverage delivery system of claim 17 wherein the nozzle is part of the holder.
